(19) United States
(12) Patent Application Publication
(10) Pub. No.: US 2026/0292850 A1
(43) Pub. Date: Sep. 24, 2026

(54) METHODS AND APPARATUSES FOR MULTIPLE CHANNEL ACCESS OVER SIDELINK

(71) Applicant: LENOVO (BEIJING) LIMITED, Beijing (CN)

(72) Inventors: Xin GUO, Beijing (CN); Haipeng LEI, Beijing (CN); Zhennian SUN, Beijing (CN); Xiaodong YU, Beijing (CN)

(21) Appl. No.: 19/168,575

(22) PCT Filed: Jul. 24, 2023
(86) PCT No.: PCT/CN2023/108983

§ 371 Date: Sep. 24, 2025

(51) Int. Cl. H04W 72/25; H04W 74/0808

(52) U.S. Cl. CPC H04W 72/25; H04W 74/0808

(57) ABSTRACT

Various aspects of the present disclosure relate to methods and apparatuses for multiple channel access over sidelink (SL). According to an embodiment of the present disclosure, a user equipment (UE) can include: at least one memory; and at least one processor coupled with the at least one memory and configured to cause the UE to: select a set of channels for a transmission over SL, wherein the transmission is one of: sidelink synchronization signal block transmission, SL transmission, or physical sidelink feedback channel transmission; and determine availability of each channel within the set of channels by performing a multiple channel access procedure of Type-independent or a multiple channel access procedure of Type-dependent on the set of channels for the transmission.

### TECHNICAL FIELD

The present disclosure relates to wireless communications, and more specifically to methods and apparatuses for multiple channel access over sidelink (SL).

### BACKGROUND

A wireless communications system may include one or multiple network communication devices, such as base stations (BSs), which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrases “based on” and “according to” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Some implementations of the methods and apparatuses described herein may include a UE for wireless communication. The UE may include: at least one memory; and at least one processor coupled with the at least one memory and configured to cause the UE to: select a set of channels for a transmission over SL, wherein the transmission is one of: sidelink synchronization signal block (S-SSB) transmission, SL transmission, or physical sidelink feedback channel (PSFCH) transmission; and determine availability of each channel within the set of channels by performing a multiple channel access procedure of Type-independent or a multiple channel access procedure of Type-dependent on the set of channels for the transmission.

In some implementations of the UE described herein, in the multiple channel access procedure of Type-independent: a channel access procedure is performed on each channel within the set of channels independently; and a channel access type on each channel within the set of channels is determined according to whether the channel is within a channel occupancy time (COT) or whether the channel is within a COT shared to the UE for performing the transmission.

In some implementations of the UE described herein, in the multiple channel access procedure of Type-dependent: in the case that at least one channel within the set of channels is outside COT(s), a Type-1 dynamic channel access procedure is performed on a first channel within the at least one channel, and a Type-2 dynamic channel access procedure is performed on each remaining channel within the set of channels other than the first channel; or in the case that all channels within the set of channels are within COT(s), a Type-2 dynamic channel access procedure is performed on each channel within the set of channels independently.

In some implementations of the UE described herein, in the case that the transmission is S-SSB transmission, to select the set of channels, the at least one processor is configured to cause the UE to: randomly select channel(s) within a frequency range; prioritize selecting an anchor channel; or prioritize selecting at least one channel outside COT(s) in the case of the multiple channel access procedure of Type-dependent.

In some implementations of the UE described herein, to perform the multiple channel access procedure of Type-independent for S-SSB transmission, the at least one processor is configured to cause the UE to: individually determine a channel access type on each channel within the set of channels according to whether a target S-SSB occasion on the channel is within a COT; and perform a channel access procedure on each channel within the set of channels based on the channel access type determined individually for each channel.

In some implementations of the UE described herein, in the case that the transmission is S-SSB transmission, the at least one processor is further configured to cause the UE to: in the case that an anchor channel within the set of channels is determined to be available, select the anchor channel to perform the S-SSB transmission; or in the case that no anchor channel is determined to be available: randomly select a channel from all available channels within the set of channels to perform the S-SSB transmission; randomly select a channel from at least one available channel which is within the set of channels and within COT(s) to perform the S-SSB transmission; select all available channels within the set of channels to perform the S-SSB transmission; select all available channels which are within the set of channels and within COT(s) to perform the S-SSB transmission; or select channel(s) from at least one channel which is within the set of channels and within COT(s) to perform the S-SSB transmission based on channel access priority class(es) (CAPC(s)) corresponding to the COT(s).

In some implementations of the UE described herein, in the case of performing the multiple channel access procedure of Type-independent for SL transmission, to select the set of channels, the at least one processor is configured to cause the UE to: prioritize selecting a channel which is within a COT shared to the UE at least when the SL transmission is intended for a UE initiating the COT.

In some implementations of the UE described herein, a remaining COT duration of the COT satisfies a transmission requirement of the UE.

In some implementations of the UE described herein, to perform the multiple channel access procedure of Type-independent for SL transmission, the at least one processor is configured to cause the UE to: individually determine a channel access type on each channel within the set of channels according to whether the channel is within a COT shared to the UE for performing at least one SL transmission and whether the SL transmission is at least intended for a UE initiating the COT; and perform a channel access procedure on each channel within the set of channels based on the channel access type determined individually for each channel.

In some implementations of the UE described herein, in the case that the transmission is SL transmission, the at least one processor is further configured to cause the UE to: select all channels which are determined to be available to perform the SL transmission.

In some implementations of the UE described herein, in the case that the transmission is PSFCH transmission, to select the set of channels, the at least one processor is configured to cause the UE to: select channel(s) whose PSFCH resource(s) correspond to SL transmission(s) towards which the UE transmits hybrid automatic repeat request (HARQ) feedback(s).

In some implementations of the UE described herein, to perform the multiple channel access procedure of Type-independent for PSFCH transmission, the at least one processor is configured to cause the UE to: individually determine a channel access type on each channel within the set of channels according to whether the channel is within a COT shared to the UE for performing PSFCH transmission(s) and whether at least one of the PSFCH transmission(s) is intended for a UE initiating the COT; and perform a channel access procedure on each channel within the set of channels based on the channel access type determined individually for each channel.

In some implementations of the UE described herein, in the case that the transmission is PSFCH transmission, the at least one processor is further configured to cause the UE to: select all channels which are determined to be available to perform PSFCH transmission(s); or drop PSFCH transmission(s) according to priority(ies) of corresponding SL transmission(s) in the case that the UE cannot transmit PSFCH on all channels which are determined to be available.

In some implementations of the UE described herein, to perform the multiple channel access procedure of Type-dependent for S-SSB transmission, the at least one processor is configured to cause the UE to: in the case that at least one channel within the set of channels is outside COT(s): select a first channel within the at least one channel; perform a Type-1 dynamic channel access procedure on the first channel to determine whether an S-SSB occasion in the first channel is available for S-SSB transmission; and perform a Type-2 dynamic channel access procedure on each remaining channel within the set of channels other than the first channel before a starting point of the S-SSB occasion in the first channel; or in the case that all channels within the set of channels are within COT(s), perform a Type-2 dynamic channel access procedure on each channel within the set of channels independently.

In some implementations of the UE described herein, in the case of performing the multiple channel access procedure of Type-dependent for SL transmission, to select the set of channels, the at least one processor is configured to cause the UE to prioritize selecting at least one channel outside COT(s).

In some implementations of the UE described herein, to perform the multiple channel access procedure of Type-dependent for SL transmission, the at least one processor is configured to cause the UE to: in the case that at least one channel within the set of channels is outside COT(s): select a first channel within the at least one channel; perform a Type-1 dynamic channel access procedure on the first channel; and perform a Type-2 dynamic channel access procedure on each remaining channel within the set of channels other than the first channel before the SL transmission on the first channel; or in the case that all channels within the set of channels are within COT(s), perform a Type-2 dynamic channel access procedure on each channel within the set of channels independently.

In some implementations of the UE described herein, in the case of performing the multiple channel access procedure of Type-dependent for SL transmission, the at least one processor is further configured to cause the UE to: in the case that a channel which is determined to be available is within a COT, determine whether to perform the SL transmission on the channel based on a remaining COT duration of the COT.

In some implementations of the UE described herein, to perform the multiple channel access procedure of Type-dependent for PSFCH transmission, the at least one processor is configured to cause the UE to: in the case that at least one channel within the set of channels is outside COT(s): select a first channel within the at least one channel; perform a Type-1 dynamic channel access procedure on the first channel to determine whether a PSFCH occasion in the first channel is available for PSFCH transmission; and perform a Type-2 dynamic channel access procedure on each remaining channel within the set of channels other than the first channel before a starting point of the PSFCH occasion in the first channel; or in the case that all channels within the set of channels are within COT(s), perform a Type-2 dynamic channel access procedure on each channel within the set of channels independently.

In some implementations of the UE described herein, the at least one processor is further configured to cause the UE to: for a channel with sub-carrier spacing (SCS) being 60 KHz, keep two symbols prior to an S-SSB occasion for performing a channel access procedure in the case that the S-SSB occasion is within a COT.

Some implementations of the methods and apparatuses described herein may include a processor for wireless communication. The processor may include: at least one controller coupled with at least one memory and configured to cause the processor to: select a set of channels for a transmission over SL, wherein the transmission is one of: S-SSB transmission, SL transmission, or PSFCH transmission; and determine availability of each channel within the set of channels by performing a multiple channel access procedure of Type-independent or a multiple channel access procedure of Type-dependent on the set of channels for the transmission.

Some implementations of the methods and apparatuses described herein may include a BS for wireless communication. The BS may include: at least one memory; and at least one processor coupled with the at least one memory and configured to cause the BS to: transmit, to a UE, configuration information for multiple channel access over SL, wherein the configuration information indicates: a CAPC threshold for the UE to select channel(s) for perform S-SSB transmission; or a COT duration threshold for the UE to determine whether to perform a sidelink transmission on a channel.

In some implementations of the BS described herein, the at least one processor is configured to cause the BS to transmit the configuration information via at least one of: a master information block (MIB) message, a system information block (SIB) message, a radio resource control (RRC) signaling, a medium access control (MAC) control element (CE), or downlink control information (DCI).

Some implementations of the methods and apparatuses described herein may include a method performed by a UE. The method may include: selecting a set of channels for a transmission over SL, wherein the transmission is one of: S-SSB transmission, SL transmission, or PSFCH transmission; and determining availability of each channel within the set of channels by performing a multiple channel access procedure of Type-independent or a multiple channel access procedure of Type-dependent on the set of channels for the transmission.

Some implementations of the methods and apparatuses described herein may include a method performed by a BS. The method may include: transmitting, to a UE, configuration information for multiple channel access over SL, wherein the configuration information indicates: a CAPC threshold for the UE to select channel(s) for perform S-SSB transmission; or a COT duration threshold for the UE to determine whether to perform a sidelink transmission on a channel.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an example of a wireless communications system in accordance with aspects of the present disclosure.

FIG. 2A illustrates an exemplary S-SSB slot in accordance with aspects of the present disclosure.

FIG. 2B illustrates an exemplary distribution of S-SSB occasions in the time domain in accordance with aspects of the present disclosure.

FIG. 2C illustrates another exemplary distribution of S-SSB occasions in the time domain in accordance with aspects of the present disclosure.

FIG. 3 illustrates a flowchart of an exemplary method performed by a UE in accordance with aspects of the present disclosure.

FIG. 4 illustrates exemplary locations of S-SSB occasion(s) and a COT for sidelink transmission in a channel in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of a BS in accordance with aspects of the present disclosure.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) long-term evolution (LTE) and LTE advanced, 3GPP 5G new radio (NR), 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

Aspects of the present disclosure are described in the context of a wireless communications system.

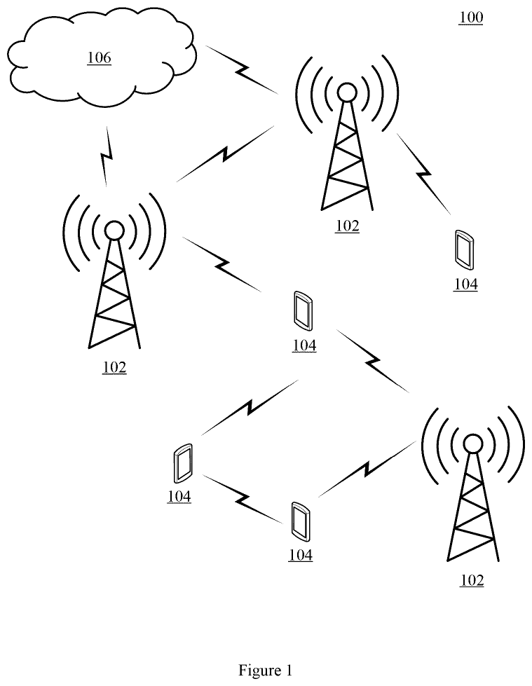

FIG. 1 illustrates an example of a wireless communications system 100 in accordance with aspects of the present disclosure. The wireless communications system 100 may include one or more network equipments (NEs) (e.g., BSs) 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NEs 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NEs 102 may communicate with each other directly. In some other implementations, the NEs 102 may communicate with each other indirectly (e.g., via the CN 106. In some implementations, one or more NEs 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (e.g., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=²) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (e.g., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In NR, accommodating multiple uncoordinated UEs in an unlicensed spectrum requires channel access procedures defined for NR. Following a successful channel access procedure performed by a communicating node, the channel can be used by the communicating node during a period until the end of the period. Such a period may be referred to as a COT. During a COT, one or more transmissions may be exchanged between the communicating nodes, wherein a transmission may be a downlink (DL) transmission or an uplink (UL) transmission.

Dynamic channel access procedures are usually used by a BS or a UE to access a channel in an unlicensed spectrum. Dynamic channel access procedures may be based on listen-before-talk (LBT), where a transmitter listens to potential transmission activity on a channel prior to transmitting and applies a random back-off time in some cases. Two main types of dynamic channel access procedures may be defined in NR. One is Type-1 dynamic channel access procedure, which is also referred to as LBT type 1 or LBT cat4. The other is Type-2 dynamic channel access procedure, which is also referred to as LBT type 2.

Type-1 dynamic channel access procedure may be used to initiate data transmission at the beginning of a COT. The initiator for the Type-1 dynamic channel access procedure may be either a BS or a UE. The Type-1 dynamic channel access procedure may be summarized as follows.

First, the initiator listens and waits until a channel (e.g., a frequency channel) is available during at least one period referred to as a defer duration. The defer duration may consist of 16 μs and a number (e.g., “mₚ” in the following Table 1 or Table 2, which will be illustrated below) of 9 μs slots. As shown in Table 1 and Table 2, a value of “mₚ” depends on a value of CAPC (represented as “p”). Accordingly, the defer duration depends on the value of CAPC as shown in the following Table 1 or Table 2. A channel is declared to be available if the received energy during at least 4 μs of each 9 μs slot is below a threshold.

Once the channel has been declared available during the defer duration, the transmitter starts a random back-off procedure during which it will wait a random period of time.

The UE starts the random back-off procedure by initializing a back-off timer with a random number within a contention window (CW). The random number is drawn from a uniform distribution [0, CW] and represents that the channel must be available for a timer duration (e.g., denoted by the random number multiplying 9 μs) before transmission can take place. The value of “CW” may be selected from “allowed CWₚ sizes” (the minimum value is represented as CWₘᵢₙₚ and the maximum value is represented as CWₘₐₓₚ) in the following Table 1 or Table 2, which depends on a value of CAPC.

The back-off timer is decreased by one for each sensing slot duration (e.g., 9 μs) the channel is sensed to be idle; whenever the channel is sensed to be busy, the back-off timer is put on hold until the channel has been idle for a defer duration.

Once the back-off timer has expired (e.g., the back-off timer is decreased to be 0), the random back-off procedure is completed, and the transmitter has acquired the channel and can use it for transmission up to a maximum channel occupancy time (MCOT) (e.g., T_{mcot,p} in the following Table 1 or T_{ulmcot,p} in the following Table 2, which depends on a value of CAPC).

The following Table 1 and Table 2 illustrate exemplary CAPC for DL and CAPC for UL, respectively, and corresponding values of mₚ, CWₘᵢₙₚ, CWₘₐₓₚ, T_{mcot,p}, T_{ulmcot,p} and allowed CWₚ sizes. Table 1 is the same as Table 4.1.1-1 in TS 37.213 and Table 2 is the same as Table 4.2.1-1 in TS 37.213. When a BS intends to initiate a channel occupancy for DL transmission, it may determine a CAPC value before performing a Type-1 channel access procedure, and then determine the corresponding values (e.g., mₚ, CWₘᵢₙₚ, CWₘₐₓₚ, T_{mcot,p} and allowed CWₚ sizes) used in the Type-1 channel access procedure according to Table 1. When a UE intends to initiate a channel occupancy for UL transmission, it may determine a CAPC value before performing a Type-1 channel access procedure, and then determine the corresponding values (e.g., mₚ, CWₘᵢₙₚ, CWₘₐₓₚ, T_{ulmcot,p}, and allowed CWₚ sizes) used in the Type-1 channel access procedure according to Table 2.

TABLE 1
Channel Access Priority Class for DL

| Channel | | | | | |
|---|---|---|---|---|---|
| Access | | | | | |
| Priority | | | | | allowed |
| Class (p) | mₚ | CWₘᵢₙₚ | CWₘₐₓₚ | T_{mcot;p} | CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or | {15, 31, 63} |
| | | | | 10 ms | |
| 4 | 7 | 15 | 1023 | 8 or | {15, 31, 63, 127, |
| | | | | 10 ms | 255, 511, 1023} |

TABLE 2
Channel Access Priority Class for UL

| Channel | | | | | |
|---|---|---|---|---|---|
| Access | | | | | |
| Priority | | | | | allowed |
| Class (p) | mₚ | CWₘᵢₙₚ | CWₘₐₓₚ | T_{ulmcot;p} | CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | 15, 31, 63, 127, |
| | | | | 10 ms | 255, 511, 1023 } |

NOTE1:
For p = 3, 4, T_{ulmcot;p} = 10 ms if the higher layer parameter ‘absenceOfAnyOtherTechnology-r14’ indicates TRUE, otherwise, T_{ulmcot;p} = 6 ms.
NOTE 2:
When T_{ulmcot;p} = 6 ms it may be increased to 8 ms by inserting one or more gaps. The minimum duration of a gap shall be 100 us. The maximum duration before including any such gap shall be 6 ms.

The size of the contention window may be adjusted based on HARQ reports received from the transmitter during a reference interval, which covers the beginning of the COT. For each received HARQ report, the contention window is (approximately) doubled up to the limit CW_{max,p} if a negative HARQ report (e.g., non-acknowledgement (NACK)) is received. For a positive HARQ report (e.g., acknowledgement (ACK)), the contention window is reset to its minimum value, i.e., CW=CW_{min,p}.

Type-2 dynamic channel access procedure may be used for COT sharing and transmission of discovery bursts. Depending on a duration of a gap (also referred to as “COT sharing gap”) in the COT, Type-2 dynamic channel access procedure may be further classified into the following three procedures, wherein which procedure to be used may be determined depending on the duration of the gap between two transmission bursts.
Type 2A dynamic channel access procedure (also referred to as LBT cat2 or LBT type 2A): which is used when the gap is 25 μs or more for transmission of the discovery bursts.
Type 2B dynamic channel access procedure (also referred to as LBT type 2B): which is used when the gap is 16 μs.
Type 2C dynamic channel access procedure (also referred to as LBT type 2C): which is used when the gap is 16 μs or less after the preceding transmission burst.

For Type 2C dynamic channel access procedure, no idle sensing is required between the transmission bursts. In such scenario, the duration of a transmission burst is limited to at most 584 μs. Such a short transmission burst may carry small amount of user data, uplink control information (UCI) such as HARQ status reports and channel state information (CSI) reports.

Type 2A dynamic channel access procedure and Type 2B dynamic channel access procedure may be similar to Type-1 dynamic channel access procedure but without the random back-off. That is, in Type 2A dynamic channel access procedure and Type 2B dynamic channel access procedure, if a channel is detected to be idle in the gap, it is declared to be available; if it is detected to be busy, the COT sharing has failed and the transmission cannot occur using COT sharing in this COT. If the COT sharing gap is 16 μs, Type 2B dynamic channel access procedure may be used and the channel must be detected to be idle in the 16 μs gap prior to the next transmission burst. If the COT sharing gap is 25 μs or longer, Type 2A dynamic channel access procedure may be used and the channel must be detected to be idle during at least 25 μs immediately preceding the next transmission burst.

The above embodiments provide several dynamic channel access procedures in an unlicensed spectrum for NR. These dynamic channel access procedures may also apply for sidelink transmissions in an unlicensed spectrum.

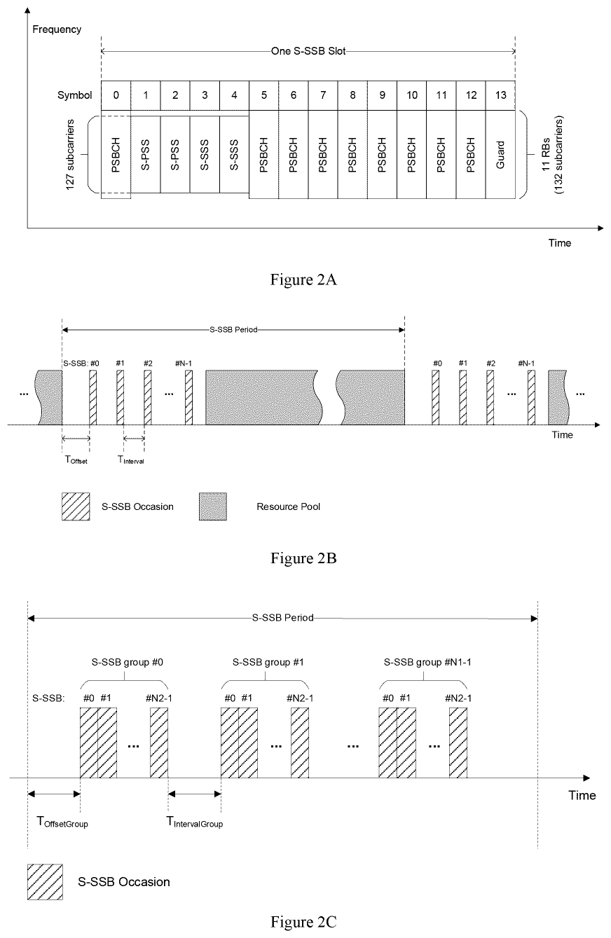

Sidelink synchronization information is carried in an S-SSB that consists of physical sidelink broadcast channel (PSBCH), sidelink primary synchronization signal (S-PSS) and sidelink secondary synchronization signal (S-SSS). FIG. 2A illustrates an exemplary S-SSB slot according to some embodiments of the present disclosure. In the example of FIG. 2A, a normal cyclic prefix (CP) is used.

Referring to FIG. 2A, an S-SSB occupies one slot in the time domain and occupies 11 resource blocks (RBs) in the frequency domain. Each RB spans 12 subcarriers, thus the S-SSB bandwidth is 132 (11×12) subcarriers. In the example of FIG. 2A, the S-SSB slot may include 14 OFDM symbols in total, e.g., symbol #0 to symbol #13. The S-PSS is transmitted repeatedly on the second and third symbols in the S-SSB slot, e.g., symbol #1 and symbol #2. The S-SSS is transmitted repeatedly on the fourth and fifth symbols in the S-SSB slot, e.g., symbol #3 and symbol #4. The S-PSS and the S-SSS occupy 127 subcarriers in the frequency domain, which are from the third subcarrier relative to the start of the S-SSB bandwidth up to the 129th subcarrier.

The S-PSS and the S-SSS are jointly referred to as the sidelink synchronization signal (SLSS). The SLSS is used for time and frequency synchronization. By detecting the SLSS sent by a synchronization reference UE (also referred to as a SyncRef UE), a UE is able to synchronize to the SyncRefUE and estimate the beginning of the frame and carrier frequency offsets.

The S-PSS may be generated from the maximum length sequences (m-sequences) that use the same design (i.e., generator polynomials, initial values and cyclic shifts, etc.) which is used for generating the m-sequences in the primary synchronization signal (PSS) in the 3GPP documents. In NR Uu, there are three candidate sequences for PSS. However, only two candidate sequences are used for S-PSS.

The S-SSS may be generated from the Gold sequences that use the same design (i.e., generator polynomials, initial values and cyclic shifts, etc.) which is utilized for generating the Gold sequences for the secondary synchronization signal (SSS) in the 3GPP documents. This results in 336 candidate sequences for S-SSS like for the SSS in NR Uu.

For the transmission of SLSS within an S-SSB, a SyncRef UE may select an S-PSS and an S-SSS out of the candidate sequences based on an SLSS identifier (ID). The SLSS ID represents an identifier of the SyncRefUE and conveys a priority of the SyncRefUE as in LTE vehicle-to-everything (V2X). Each SLSS ID corresponds to a unique combination of an S-PSS and an S-SSS out of the 2 S-PSS candidate sequences and the 336 S-SSS candidate sequences.

The main purpose of the PSBCH is to provide system-wide information and synchronization information that is required by a UE for establishing a sidelink connection. In the example of FIG. 2A, the PSBCH is transmitted on the first symbol (e.g., symbol #0) and the eight symbols (e.g., symbol #5 to symbol #12) after the S-SSS in the S-SSB slot. In the case that an extended CP is used, the PSBCH is transmitted on the first symbol and the six symbols after the S-SSS in the S-SSB slot. The PSBCH occupies 132 subcarriers in the frequency domain. The PSBCH in the first symbol of the S-SSB slot is used for automatic gain control (AGC). The last symbol, e.g., symbol #13, in the S-SSB slot is used as a guard symbol.

The structure of S-SSB slot in FIG. 2A is only for illustrative purpose. It is contemplated that along with developments of network architectures and new service scenarios, the S-SSB may have other structures (for example, the S-SSB may include 4 OFDM symbols or 6 OFDM symbols in the time domain), which should not affect the principle of the present application.

FIG. 2B illustrates an exemplary distribution of S-SSB occasions in the time domain according to some embodiments of the present disclosure.

FIG. 2B illustrates an S-SSB period as an example. Resource pool is also illustrated in the figure. A resource pool may define the overall time and frequency domain resources that can be used for SL transmission within a carrier. The SL transmission in the embodiments of the present application may refer to at least one of physical sidelink control channel (PSCCH) transmission or physical sidelink shared channel (PSSCH) transmission. In the time domain, the resource pool consists of a set of slots repeated over a resource pool period. Although the set of slots within the resource pool are logically organized in a consecutive way, actually the slots within the resource pool may be discretely distributed in the time domain.

As shown in FIG. 2B, in the S-SSB period, N S-SSB occasions are included, which are labeled by S-SSB occasion #0, S-SSB occasion #1, S-SSB occasion #2, . . . , S-SSB occasion #N-1, respectively.

A length of the S-SSB period is marked as “S-SSB Period” in FIG. 2B. There is a time offset between the starting of the S-SSB period and the first S-SSB occasion within the S-SSB period, which is marked as “T_{Offset}” in FIG. 2B. There is a time interval between two adjacent S-SSB occasions (e.g., between the ending point of the former S-SSB occasion and the starting point of the latter S-SSB occasion), which is marked as “T_{Interval}” in FIG. 2B.

In 3GPP Release 16 (Rel-16) or Release 17 (Rel-17), the S-SSB period may include 160 ms, as specified in NR V2X. However, along with developments of network architectures and new service scenarios, the S-SSB period may have other values, which should not affect the principle of the disclosure. In the examples of FIG. 2B, the distribution of S-SSB occasion(s) may be denoted by at least one of the following parameters: S-SSB period, T_{Offset}, T_{Interval}, or N as stated above.

FIG. 2C illustrates an exemplary distribution of S-SSB occasions in the time domain, which are organized in a grouping manner, according to some embodiments of the present disclosure.

FIG. 2C illustrates an S-SSB period as an example. A length of the S-SSB period is marked as “S-SSB Period” in FIG. 2C. The S-SSB period includes N1 S-SSB groups, which are S-SSB group #0, S-SSB group #1, . . . , and S-SSB group #N1-1. Each S-SSB group includes N2 consecutive S-SSB occasions, which are S-SSB occasion #0, S-SSB occasion #1, . . . , and S-SSB occasion #N2-1.

There is a time offset between the starting of the S-SSB period and a starting of the first S-SSB group within the S-SSB period, which is marked as “T_{OffsetGroup}” in FIG. 2C. There is a time interval between two adjacent S-SSB groups (e.g., between the ending point of the former S-SSB group and the starting point of the latter S-SSB group), which is marked as “T_{IntervalGroup}” in FIG. 2C. Accordingly, the distribution of S-SSB occasions in the example of FIG. 2C may be defined by at least one of the following parameters: the parameter “S-SSB Period,” the parameter “T_{OffsetGroup},” the parameter “T_{IntervalGroup},” the parameter “N1,” or the parameter “N2.”

According to some embodiments of the present application, for unlicensed spectra, a frequency range (e.g., a BWP, a carrier, a resource pool, etc.) may be divided into multiple channels upon which a channel access procedure is defined. Each channel may be referred to as an RB set. Operating on the carrier may require guard bands between RB sets. In some embodiments, the size of the guard bands may be chosen such that no filtering is needed to ensure that transmission on one RB set does not cause significant interference to a neighboring RB set not available for transmission.

For example, the concept of “RB set” is specified in Release 16 5G NR in unlicensed spectrum (NR-U), which defines the exact available RBs without RBs in either inter-cell guard band or intra-cell guard band. The guard band and RB set are configured by RRC signaling in unit of common resource block (CRB). In detail, when a UE is configured with intraCellGuardBand for a carrier, the UE is provided with N_{RB-set}−1 intra-cell guard bands on the carrier, each defined by a start CRB and an end CRB, i.e.,

$${GB}_{s}^{start , μ} and {GB}_{s}^{end , μ} ,$$

respectively. The intra-cell guard bands separate N_{RB-set} RB sets, each defined by a start CRB and an end CRB, i.e.,

$${RB}_{s}^{start , μ} and {RB}_{s}^{end , μ} ,$$

respectively. The UE determines

$${RB}_{0}^{start , μ} = {N}_{grid}^{start , μ} , {RB}_{{N}_{RB - set} - 1}^{end , μ} = {N}_{grid}^{start , μ} + {N}_{grid}^{size , μ} ,$$

and the remaining end and start CRBs as

$${RB}_{s}^{end , μ} = {GB}_{s}^{start , μ} - 1 and {RB}_{s + 1}^{start , μ} = {GB}_{s}^{end , μ} + 1.$$

When the UE is not configured with intraCellGuardBand, the UE determines intra-cell guard band and corresponding RB set according to the default intra-cell guard band pattern from TS38.101 corresponding to y and carrier size

$${N}_{grid}^{size , μ} .$$

The specific definitions of the variables or parameters as mentioned above can be found in 3GPP standard documents.

As an example, a carrier wider than 20 MHz may be divided into multiple 20 MHz channels upon which a channel access procedure is defined. Each 20 MHz channel may be referred to as one RB set.

The following Table 3 shows the number of RBs (e.g., N_{RB}) included in different bandwidths for different SCSs for FR1 (e.g., 450 MHz-7125 MHz).

TABLE 3
Max transmission bandwidth configuration N_{RB} for FR1

| | 5 | 10 | 15 | 20 | 25 | 30 | 40 | 50 | 60 | 80 | 100 |
|---|---|---|---|---|---|---|---|---|---|---|---|
| SCS | MHz | MHz | MHz | MHz | MHz | MHz | MHz | MHz | MHz | MHz | MHz |
| (kHz) | N_{RB} | N_{RB} | N_{RB} | N_{RB} | N_{RB} | N_{RB} | N_{RB} | N_{RB} | N_{RB} | N_{RB} | N_{RB} |
| 15 | 25 | 52 | 79 | 106 | 133 | [160] | 216 | 270 | N/A | N/A | N/A |
| 30 | 11 | 24 | 38 | 51 | 65 | [78] | 106 | 133 | 162 | 217 | 273 |
| 60 | N/A | 11 | 18 | 24 | 31 | [38] | 51 | 65 | 79 | 107 | 135 |

Referring to Table 3, taking 20 MHz bandwidth as an example, for 15 kHz SCS, the 20 MHz bandwidth includes 106 RBs (e.g., an RB set may include 106 RBs); for 30 kHz SCS, the 20 MHz bandwidth includes 51 RBs.

In NR unlicensed spectrum (NR-U), a BS can access multiple channels to perform downlink transmissions according to a Type-A multiple channel access procedure or a Type-B multiple channel access procedure.

In the Type-A multiple channel access procedure, a BS may perform a channel access procedure (e.g., Type-1 channel access procedure) on each channel cᵢ ∈ C, where C is a set of channels on which the BS intends to transmit, and i=0, 1, . . . q−1, and q is the number of channels on which the BS intends to transmit.

In the Type-A multiple channel access procedure, if a BS configures a carrier without intra-cell guard bands, the BS may not transmit on channel cᵢ ∈ C within the bandwidth of the carrier, if the BS fails to access any of the channels in the carrier bandwidth.

In the Type-B multiple channel access procedure, a BS may perform operations as follows:
1) The BS may select a channel cⱼ ∈ C, where C (e.g., {c₀, c₁, . . . , c_{q-1}}) is a set of channels on which the BS intends to transmit, and q is the number of channels on which the BS intends to transmit. The channel cⱼ may be selected by the BS as follows:
   the BS may select cⱼ by uniformly randomly choosing cⱼ from C before each transmission on multiple channels cⱼ ∈ C, or
   the BS may select cⱼ no more frequently than once every 1 second.
2) To transmit on channel cⱼ, the BS may perform a Type-1 channel access procedure on channel cⱼ.
3) To transmit on channel cᵢ≠cⱼ, cᵢ ∈ C, for each channel cᵢ, the BS may sense the channel cᵢ for at least a sensing interval T_{mc}=25us immediately before the transmission on channel cⱼ, and the BS may transmit on channel cᵢ immediately after sensing the channel cᵢ to be idle for at least the sensing interval T_{mc}. The channel cᵢ is considered to be idle for T_{mc} if the channel cᵢ is sensed to be idle during all the time durations in which such idle sensing is performed on the channel cⱼ in given interval T_{mc}.

In the Type-B multiple channel access procedure, the BS may not transmit a transmission on a channel cᵢ≠cⱼ, cᵢ ∈ C, for a period exceeding T_{m cot,p} as given in Table 1, where the value of T_{m cot,p} is determined using the channel access parameters used for channel cⱼ.

In the Type-B multiple channel access procedure, if a BS configures a carrier without intra-cell guard band(s), the BS may not transmit on channel cᵢ ∈ C within the bandwidth of the carrier, if the BS fails to access any of the channels in the carrier bandwidth.

The type-A multiple channel access procedure and Type-B multiple channel access procedure in NR-U may be used as the baseline for designing multiple channel access procedures in SL unlicensed spectrum (SL-U). However, since both type-A multiple channel access procedure and Type-B multiple channel access procedure are designed for NR-U where the channels for transmission are determined and allocated by a BS, these procedures are not suitable to be directly used in SL-U. For example, in SL-U, a UE may determine which channel(s) to transmit on its own. The UE may determine a channel access type (e.g., Type-1 or Type-2) used on a channel by considering information of COT. In addition, selecting a channel for S-SSB transmission, SL transmission (e.g., at least one of a PSCCH transmission or a PSSCH transmission), or PSFCH transmission may need to consider their individual characteristics. Therefore, how to design multiple channel access procedures for SL-U needs to be studied.

Embodiments of the present disclosure provide solutions for multiple channel access in SL-U. Specifically, for dynamic channel access mode with multi-channel case in SL-U, embodiments of the present disclosure provide multiple channel access procedures for S-SSB transmission, SL transmission, and PSFCH transmission. The multiple channel access procedures in SL-U in the embodiments of the present disclosure may be based on the Type-A and Type-B multiple channel access procedures in NR-U and further consider the resource utilization conditions, characteristics of SL-U, and characteristics of the transmission (e.g., S-SSB transmission, SL transmission, or PSFCH transmission). More details will be described in the following text in combination with the appended drawings.

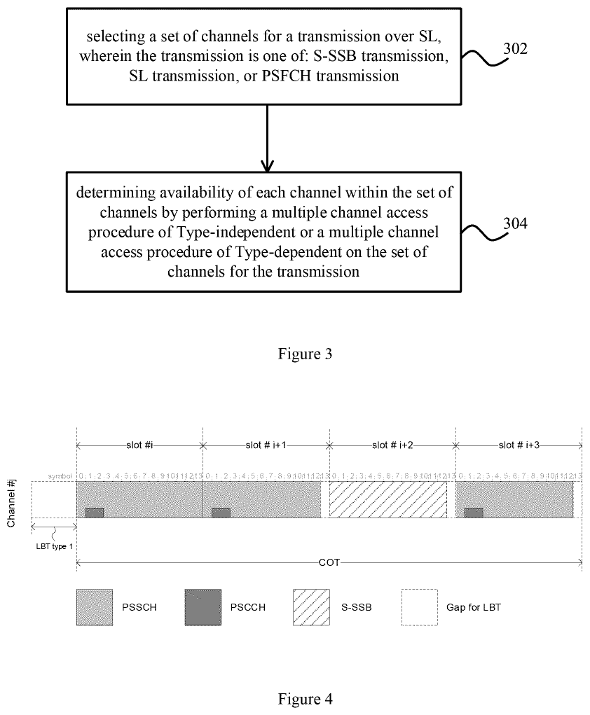

FIG. 3 illustrates a flowchart of an exemplary method in accordance with aspects of the present disclosure. The operations of the method illustrated in FIG. 3 may be performed by a UE (e.g., UE 104 in FIG. 1) as described herein or other apparatus with the like functions. In some implementations, the UE may execute a set of instructions to control functional elements of the UE to perform the described operations or functions.

As shown in FIG. 3, in step 302, the UE may select a set of channels for a transmission over SL. The transmission may be one of: S-SSB transmission, SL transmission (e.g., PSCCH transmission and/or PSSCH transmission), or PSFCH transmission. As described above, a channel may also be referred to as an RB set.

In step 304, the UE may determine availability of each channel within the set of channels by performing a multiple channel access procedure of Type-independent or a multiple channel access procedure of Type-dependent on the set of channels for the transmission.

In some embodiments, in the multiple channel access procedure of Type-independent: a channel access procedure is performed on each channel within the set of channels independently; and a channel access type on each channel within the set of channels is determined according to whether the channel is within a COT or whether the channel is within a COT shared to the UE for performing the transmission. The channel access type may refer to, e.g., either Type-1 dynamic channel access procedure or Type-2 dynamic channel access procedure as described above.

In some embodiments, in the multiple channel access procedure of Type-dependent: in the case that at least one channel within the set of channels is outside COT(s), a Type-1 dynamic channel access procedure is performed on a first channel within the at least one channel, and a Type-2 dynamic channel access procedure is performed on each remaining channel within the set of channels other than the first channel; in the case that all channels within the set of channels are within COT(s), a Type-2 dynamic channel access procedure is performed on each channel within the set of channels independently.

Whether to perform the multiple channel access procedure of Type-independent or the multiple channel access procedure of Type-dependent may be up to the UE's implementation.

The following embodiments provide specific operations in steps 302 and 304 when the multiple channel access procedure of Type-independent or the multiple channel access procedure of Type-dependent is performed for different transmissions.

### Embodiment 1

In Embodiment 1, the UE may perform the multiple channel access procedure of Type-independent in step 304. Embodiment 1 may be divided into Embodiment 1-1, Embodiment 1-2, and Embodiment 1-3 for different transmissions.

### Embodiment 1-1

In Embodiment 1-1, the UE may intend to transmit S-SSB and determine to perform the multiple channel access procedure of Type-independent. That is, in Embodiment 1-1, the transmission for which the UE selects the set of channels in step 302 is S-SSB transmission, and the UE intends to select at least one channel from the set of channels for S-SSB transmission.

In some embodiments, the UE may randomly select channel(s) within a frequency range (e.g., a BWP, a carrier, a resource pool, etc.) to constitute the set of channels.

In some embodiments, when the UE selects the set of channels, the UE may prioritize selecting an anchor channel to be included in the set of channels. As an example, the anchor channel may refer to a channel where S-SSB indicated by sl-AbsoluteFrequencySSB-r16 as specified in 3GPP standard documents locates. As another example, the anchor channel may be defined as a channel on which default S-SSB occasions locate. Accordingly, non-anchor channel(s) may refer to the channel(s) other than the indicated anchor channel.

In step 304, the UE may determine availability of each channel within the set of channels by performing a multiple channel access procedure of Type-independent on the set of channels for S-SSB transmission. In some embodiments, performing a multiple channel access procedure of Type-independent on the set of channels for S-SSB transmission may at least include the following operations.

First, the UE may individually determine a channel access type (e.g., Type-1 or Type-2) of a channel access procedure on each channel within the set of channels according to whether a target S-SSB occasion on the channel is within a COT. Wherein, the location of the target S-SSB occasion in the time domain may be determined by a distribution of S-SSB occasions in the time domain, for example, the distribution as shown in FIG. 2B or FIG. 2C. The location of the target S-SSB occasion in the frequency domain may be indicated by a channel index or channel identity (ID). As an example, if a target S-SSB occasion on a channel is within a COT, the UE may determine that a channel access type on the channel is Type-2. Otherwise, the UE may determine that a channel access type on the channel is Type-1.

FIG. 4 illustrates exemplary locations of S-SSB occasion(s) and a COT for SL transmission in a channel in accordance with aspects of the present disclosure. In the example of FIG. 4, an S-SSB occasion is within the COT for SL transmission.

Referring to FIG. 4, in a channel (e.g., channel #j), a COT for SL transmission may start from slot #i and has a length of 4 slots (e.g., including slot #i, slot #i+1, slot #i+2, and slot #i+3). The COT may be initiated by an LBT type 1 procedure before slot #i. Each slot may include 14 OFDM symbols (e.g., from symbol 0 to symbol 13). Within the COT, slot #i+2 is an S-SSB occasion. Each of the other slots in the COT may be used for an SL transmission, which includes at least one of a PSCCH transmission or a PSSCH transmission.

When the UE knows information related to a COT, e.g., in the case that the UE is a COT initiating UE initiating the COT, a COT responding UE to which the COT initiating UE may share the COT, or a UE which detects the information related to the COT (e.g., the remaining COT duration of the COT), the UE may determine whether a target S-SSB occasion on a channel is within the COT, e.g., based on the information related to the COT and the distribution of S-SSB occasions. If the UE does not know information related to a COT, the UE may assume that a target S-SSB occasion on a channel is outside the COT. The motivation for providing a UE which detects the information related to the COT with a higher channel access opportunity (like the COT initiating UE and the COT responding UE) is that its S-SSB transmission has less impact on interruption of the COT.

After individually determining a channel access type (e.g., Type-1 or Type-2) on each channel within the set of channels, the UE may perform a channel access procedure on each channel within the set of channels based on the channel access type determined individually for each channel.

For example, in the case that the UE determines that a channel access type on a channel is Type-2, the UE may perform a Type-2 dynamic channel access procedure towards a target S-SSB occasion on the channel to determine availability of the channel (i.e., whether the channel is available). In the case that the UE determines that a channel access type on a channel is Type-1, the UE may perform a Type-1 dynamic channel access procedure towards a target S-SSB occasion on the channel to determine whether the channel is available.

Consequently, in step 304, the UE may determine availability of each channel within the set of channels. In other words, the UE may determine which channel(s) within the set of channels is(are) available.

After determining available channel(s) within the set of channels, the UE may select channel(s) from the available channel(s) to perform S-SSB transmissions. In some embodiments, the UE may prioritize performing S-SSB transmission on an anchor channel.

In some examples, in the case that an anchor channel within the set of channels is determined to be available, the UE may select the anchor channel to perform the S-SSB transmission. The UE may further determine whether to transmit S-SSB on available non-anchor channel(s) according to rules specified in SL-U.

In some other examples, in the case that no anchor channel is determined to be available in step 304, the UE may perform one of the following operations. The motivation is to reduce COT lose.
Randomly selecting a channel from all available channels within the set of channels to perform the S-SSB transmission;
Randomly selecting a channel from at least one available channel which is within the set of channels and within COT(s) to perform the S-SSB transmission;
Selecting all available channels within the set of channels to perform the S-SSB transmission;
Selecting all available channels which are within the set of channels and within COT(s) to perform the S-SSB transmission; or
Selecting channel(s) from at least one channel which is within the set of channels and within COT(s) to perform the S-SSB transmission based on CAPC(s) corresponding to the COT(s): for example, the UE may select a channel within a COT to perform the S-SSB transmission if a CAPC corresponding to the COT is higher than or equal to a CAPC threshold.

In some embodiments, the UE may obtain the CAPC threshold based on configuration (i.e., the CAPC threshold is configured for the UE). The CAPC threshold being configured for the UE refers to that: the CAPC threshold may be transmitted by e.g. a BS (e.g., NE 102 as shown in FIG. 1) to the UE via at least one of: a SIB message, a MIB message, an RRC signaling, a MAC CE, or DCI, such that the UE may receive the CAPC threshold from the BS.

In some embodiments, the UE may obtain the CAPC threshold based on pre-configuration, definition, or pre-definition (i.e., the CAPC threshold is pre-configured, defined, or pre-defined for the UE). The CAPC threshold being pre-configured, defined, or pre-defined for the UE refers to that: the CAPC threshold may be hard-wired into the UE or stored on a subscriber identity module (SIM) or universal subscriber identity module (USIM) card for the UE, such that the UE may obtain the CAPC threshold within the UE.

### Embodiment 1-2

In Embodiment 1-2, the UE may intend to transmit PSCCH and/or PSSCH and determine to perform the multiple channel access procedure of Type-independent. That is, in Embodiment 1-2, the transmission for which the UE selects the set of channels in step 302 is SL transmission, and the UE intends to select at least one channel from the set of channels for SL transmission.

In some embodiments, when the UE selects the set of channels for SL transmission, it may consider the following principle:
principle #1: when performing SL transmission(s), a responding UE can utilize a COT shared by a COT initiating UE at least when the responding UE's SL transmission(s) within channel(s) corresponding to the shared COT is intended for the COT initiating UE.

By considering principle #1, when the UE selects the set of channels for an SL transmission, the UE may prioritize selecting a channel which is within a COT shared to the UE at least when the SL transmission is intended for a UE initiating the COT. In some examples, the UE may prioritize selecting a channel which is within a COT shared to the UE at least when the SL transmission is intended for a UE initiating the COT and a remaining COT duration of the COT satisfies a transmission requirement of the UE. The motivation of such selecting method is to increase success probabilities of channel access procedure on the channel and increase the time-domain resource on the channel.

In step 304, the UE may determine availability of each channel within the set of channels by performing a multiple channel access procedure of Type-independent on the set of channels for SL transmission. In some embodiments, performing a multiple channel access procedure of Type-independent on the set of channels for SL transmission may at least include the following operations.

First, the UE may individually determine a channel access type (e.g., Type-1 or Type-2) on each channel within the set of channels according to whether the channel is within a COT shared to the UE for performing at least one SL transmission and whether the SL transmission is at least intended for a UE initiating the COT. Such channel access type determination method also takes principle #1 into consideration.

As an example, if a channel is within a COT shared to the UE (e.g., the UE is a COT responding UE) for performing at least one SL transmission and the SL transmission is at least intended for a UE initiating the COT, the UE may determine that a channel access type on the channel is Type-2. Otherwise, the UE may determine that a channel access type on the channel is Type-1.

After individually determining a channel access type (e.g., Type-1 or Type-2) on each channel within the set of channels, the UE may perform a channel access procedure on each channel within the set of channels based on the channel access type determined individually for each channel.

For example, in the case that the UE determines that a channel access type on a channel is Type-2, the UE may perform a Type-2 dynamic channel access procedure on the channel to determine availability of the channel (i.e., whether the channel is available). In the case that the UE determines that a channel access type on a channel is Type-1, the UE may perform a Type-1 dynamic channel access procedure on the channel to determine whether the channel is available.

Consequently, in step 304, the UE may determine availability of each channel within the set of channels. In other words, the UE may determine which channel(s) within the set of channels is(are) available. Then, the UE may select all channels within the set of channels which are determined to be available in step 304 to perform the SL transmission.

In some embodiments, in the case that a channel which is determined to be available is within a COT (e.g., the channel is determined to be available based on a Type-2 dynamic channel access procedure), the UE may determine whether to perform the SL transmission on the channel based on a remaining COT duration of the COT. For example, the UE may determine to perform the SL transmission on the channel if the remaining COT duration of the COT is longer than or equal to a COT duration threshold. The UE may obtain the COT duration threshold based on configuration, pre-configuration, definition, or pre-definition. All the aforementioned definitions regarding configuration, pre-configuration, definition, and pre-definition may also apply here.

In some embodiments, the starting symbol of the SL transmission may be the first symbol (e.g., symbol #0) in a slot. In some other embodiments, for slots with 2 candidate starting symbols for an SL transmission, the location of the 1^{st} starting symbol may be (pre-)configured from symbol {#0, #1, #2, #3, #4, #5, #6}per BWP, and in the case of no (pre-)configuration, the default location of the 1^{st} starting symbol is symbol #0; and the location of the 2^{nd} starting symbol may be (pre-)configured from symbol {#3, #4, #5, #6, #7}per BWP. The (pre-)configuration of the 2^{nd} starting symbol needs to meet the following requirements: within a slot, the 2^{nd} starting symbol is later than the 1^{st} starting symbol, and the number of symbols used for SL transmission from the 2^{nd} starting symbol is not smaller than 6. In such embodiments, the starting symbol of the SL transmission may be the 1^{st} starting symbol or the 2nd starting symbol.

### Embodiment 1-3

In Embodiment 1-3, the UE may intend to transmit PSFCH and determine to perform the multiple channel access procedure of Type-independent. That is, in Embodiment 1-3, the transmission for which the UE selects the set of channels in step 302 is PSFCH transmission, and the UE intends to select at least one channel from the set of channels for PSFCH transmission.

In some embodiments, the UE may select channel(s) whose PSFCH resource(s) correspond to SL transmission(s) towards which the UE transmits HARQ feedback(s) to constitute the set of channels.

In step 304, the UE may determine availability of each channel within the set of channels by performing a multiple channel access procedure of Type-independent on the set of channels for PSFCH transmission. In some embodiments, performing a multiple channel access procedure of Type-independent on the set of channels for PSFCH transmission may at least include the following operations.

First, the UE may individually determine a channel access type (e.g., Type-1 or Type-2) on each channel within the set of channels according to whether the channel is within a COT shared to the UE for performing PSFCH transmission(s) and whether at least one of the PSFCH transmission(s) is intended for a UE initiating the COT. Such channel access type determination method may take the following principle into consideration:
principle #2: when performing PSFCH transmission(s), a responding UE can utilize a COT shared by a COT initiating UE at least when at least one of the responding UE's PSFCH transmissions in a symbol/slot within channel(s) corresponding to the shared COT is intended for the COT initiating UE.

As an example, if a channel is within a COT shared to the UE (e.g., the UE is a COT responding UE) for performing PSFCH transmission(s) and at least one of the PSFCH transmission(s) is intended for a UE initiating the COT, the UE may determine that a channel access type on the channel is Type-2. Otherwise, the UE may determine that a channel access type on the channel is Type-1.

After individually determining a channel access type (e.g., Type-1 or Type-2) on each channel within the set of channels, the UE may perform a channel access procedure on each channel within the set of channels based on the channel access type determined individually for each channel.

For example, in the case that the UE determines that a channel access type on a channel is Type-2, the UE may perform a Type-2 dynamic channel access procedure towards a target PSFCH occasion on the channel to determine availability of the channel (i.e., whether the channel is available). In the case that the UE determines that a channel access type on a channel is Type-1, the UE may perform a Type-1 dynamic channel access procedure towards a target PSFCH occasion on the channel to determine whether the channel is available.

Consequently, in step 304, the UE may determine availability of each channel within the set of channels. In other words, the UE may determine which channel(s) within the set of channels is(are) available. Then, in some embodiments, the UE may select all channels within the set of channels which are determined to be available in step 304 to perform PSFCH transmission(s).

In some embodiments, in the case that the UE cannot transmit PSFCH on all channels which are determined to be available (e.g., due to a power limitation), the UE may drop PSFCH transmission(s) according to priority(ies) of corresponding SL transmission(s). For example, the UE may drop PSFCH transmission(s) whose corresponding SL transmission(s) has(have) lower priority(ies).

### Embodiment 2

In Embodiment 2, the UE may perform the multiple channel access procedure of Type-dependent in step 304. Embodiment 2 may be divided into Embodiment 2-1, Embodiment 2-2, and Embodiment 2-3 for different transmissions.

### Embodiment 2-1

In Embodiment 2-1, the UE may intend to transmit S-SSB and determine to perform the multiple channel access procedure of Type-dependent. That is, in Embodiment 2-1, the transmission for which the UE selects the set of channels in step 302 is S-SSB transmission, and the UE intends to select at least one channel from the set of channels for S-SSB transmission. For example, the set of channels may be denoted as C. Each channel in the set of channels may be denoted as cᵢ ∈ C, i=0, 1, . . . q−1, where q is the number of channels included in the set of channels, which is a positive integer.

In some embodiments, the UE may randomly select channel(s) within a frequency range (e.g., a BWP, a carrier, a resource pool, etc.) to constitute the set of channels.

In some embodiments, when the UE selects the set of channels, the UE may prioritize selecting an anchor channel to be included in the set of channels. As an example, the anchor channel may refer to a channel where S-SSB indicated by sl-AbsoluteFrequencySSB-r16 as specified in 3GPP standard documents locates. As another example, the anchor channel may be defined as a channel on which default S-SSB occasions locate. In some embodiments, when the UE selects the set of channels, the UE may prioritize selecting at least one channel outside COT(s) to be included in the set of channels.

In step 304, the UE may determine availability of each channel within the set of channels by performing a multiple channel access procedure of Type-dependent on the set of channels for S-SSB transmission. In some embodiments, performing a multiple channel access procedure of Type-dependent on the set of channels for S-SSB transmission may at least include the following operations.

In the case that at least one channel within the set of channels is outside COT(s), the UE may select (e.g., randomly select) a first channel within the at least one channel. The UE may perform a Type-1 dynamic channel access procedure on the first channel to determine whether an S-SSB occasion in the first channel is available for S-SSB transmission (i.e., whether the first channel is available). The motivation of such design is to increase the success opportunity for the channel access procedure while decreasing impact on COT. The UE perform a Type-2 dynamic channel access procedure on each remaining channel within the set of channels other than the first channel before a starting point of the S-SSB occasion in the first channel.

As an example, the at least one channel outside COT(s) may be denoted as Cₗ, wherein C₁ ⊆C, i.e., C₁ is a subset of C. The UE may perform the following operations:
The UE may select a first channel (e.g., denoted as cⱼ) from Cₗ, and perform a Type-1 dynamic channel access procedure towards an S-SSB occasion on the channel cⱼ to determine availability of the channel c₁ (e.g., whether the S-SSB occasion in the channel cⱼ is available for S-SSB transmission).
For each channel cᵢ≠cⱼ, cᵢ ∈ C, the UE may perform a Type-2 dynamic channel access procedure on the channel cᵢ before a starting point of the S-SSB occasion on the channel cⱼ to determine availability of the channel cᵢ(i.e., whether the channel is available). For example, the UE may sense the channel cᵢ for at least a sensing interval T_{mc} (e.g., T_{mc}=25us) immediately before the starting point of the S-SSB occasion on the channel cⱼ, and determine that the channel cᵢ is available after sensing the channel cᵢ to be idle for at least the sensing interval T_{mc}.

In the case that all channels within the set of channels are within COT(s), the UE may perform a Type-2 dynamic channel access procedure on each channel within the set of channels independently to determine availability of each channel (e.g., whether an S-SSB occasion in each channel is available for S-SSB transmission).

Consequently, in step 304, the UE may determine availability of each channel within the set of channels. In other words, the UE may determine which channel(s) within the set of channels is(are) available.

After determining available channel(s) within the set of channels, the UE may select channel(s) from the available channel(s) to perform the S-SSB transmission. All the embodiments for selecting channel(s) from the available channel(s) to perform the S-SSB transmission as described in Embodiment 1-1 may also apply here. Thus, details are omitted for simplicity.

### Embodiment 2-2

In Embodiment 2-2, the UE may intend to transmit PSCCH and/or PSSCH and determine to perform the multiple channel access procedure of Type-dependent. That is, in Embodiment 2-2, the transmission for which the UE selects the set of channels in step 302 is SL transmission, and the UE intends to select at least one channel from the set of channels for SL transmission. For example, the set of channels may be denoted as C. Each channel in the set of channels may be denoted as cᵢ ∈ C, i=0, 1, . . . q−1, where q is the number of channels included in the set of channels, which is a positive integer.

In some embodiments, when the UE selects the set of channels, the UE may prioritize selecting at least one channel outside COT(s) to be included in the set of channels.

In step 304, the UE may determine availability of each channel within the set of channels by performing a multiple channel access procedure of Type-dependent on the set of channels for SL transmission. In some embodiments, performing a multiple channel access procedure of Type-dependent on the set of channels for SL transmission may at least include the following operations.

In the case that at least one channel within the set of channels is outside COT(s), the UE may select (e.g., randomly select) a first channel within the at least one channel. The UE may perform a Type-1 dynamic channel access procedure on the first channel to determine whether the first channel is available for SL transmission. The motivation of such design is to increase the success opportunity for the channel access procedure while decreasing impact on COT. Then, the UE may perform the SL transmission on the first channel when the first channel is determined to be available.

In addition, the UE may perform a Type-2 dynamic channel access procedure on each remaining channel within the set of channels other than the first channel before the SL transmission (e.g., before the starting symbol of the SL transmission) in the first channel. In some embodiments, the starting symbol of the SL transmission may be the first symbol (e.g., symbol #0) in a slot. In some other embodiments, for slots with 2 candidate starting symbols for an SL transmission, the starting symbol of the SL transmission may be the aforementioned 1^{st} starting symbol or 2^{nd} starting symbol. The UE may perform the SL transmission on a remaining channel when the remaining channel is determined to be available.

As an example, the at least one channel outside COT(s) may be denoted as C₂, wherein C₂ ⊆C, i.e., C₂ is a subset of C. The UE may perform the following operations:
The UE may select a first channel (e.g., denoted as cⱼ) from C₂, and perform a Type-1 dynamic channel access procedure on the channel cⱼ to determine availability of the channel cⱼ. The UE may perform an SL transmission when the channel cⱼ is determined to be available.
For each channel cᵢ≠cⱼ, cᵢ ∈ C, the UE may perform a Type-2 dynamic channel access procedure on the channel cᵢ before the SL transmission on the channel cⱼ to determine availability of the channel cᵢ. For example, the UE may sense the channel cᵢ for at least a sensing interval T_{mc} (e.g., T_{mc}=25us) immediately before the SL transmission (e.g., before the starting symbol of the SL transmission) on the channel cⱼ, and determine that the channel cᵢ is available after sensing the channel cᵢ to be idle for at least the sensing interval T_{mc}. The UE may perform an SL transmission on the channel cᵢ when the channel cᵢ is determined to be available. For example, the UE may transmit the SL transmission on the channel cᵢ immediately after sensing the channel cᵢ to be idle for at least the sensing interval T_{mc}.

In the case that all channels within the set of channels are within COT(s), the UE may perform a Type-2 dynamic channel access procedure on each channel within the set of channels independently to determine availability of each channel. Then, the UE may select all channels within the set of channels which are determined to be available in step 304 to perform the SL transmission.

In some embodiments, in the case that a channel which is determined to be available is within a COT, the UE may determine whether to perform the SL transmission on the channel based on a remaining COT duration of the COT. For example, the UE may determine to perform the SL transmission on the channel if the remaining COT duration of the COT is longer than or equal to a COT duration threshold. The UE may obtain the COT duration threshold based on configuration, pre-configuration, definition, or pre-definition. All the aforementioned definitions regarding configuration, pre-configuration, definition, and pre-definition may also apply here.

### Embodiment 2-3

In Embodiment 2-3, the UE may intend to transmit PSFCH and determine to perform the multiple channel access procedure of Type-dependent. That is, in Embodiment 2-3, the transmission for which the UE selects the set of channels in step 302 is PSFCH transmission, and the UE intends to select at least one channel from the set of channels for PSFCH transmission. For example, the set of channels may be denoted as C. Each channel in the set of channels may be denoted as cᵢ ∈ C, i=0, 1, . . . q−1, where q is the number of channels included in the set of channels, which is a positive integer.

In some embodiments, the UE may select channel(s) whose PSFCH resource(s) correspond to SL transmission(s) towards which the UE transmits HARQ feedback(s) to constitute the set of channels.

In step 304, the UE may determine availability of each channel within the set of channels by performing a multiple channel access procedure of Type-dependent on the set of channels for PSFCH transmission. In some embodiments, performing a multiple channel access procedure of Type-dependent on the set of channels for PSFCH transmission may at least include the following operations.

In the case that at least one channel within the set of channels is outside COT(s), the UE may select (e.g., randomly select) a first channel within the at least one channel. The UE may perform a Type-1 dynamic channel access procedure on the first channel to determine whether a PSFCH occasion in the first channel is available for PSFCH transmission. The motivation of such design is to increase the success opportunity for the channel access procedure while decreasing impact on COT. The UE perform a Type-2 dynamic channel access procedure on each remaining channel within the set of channels other than the first channel before a starting point of the PSFCH occasion in the first channel.

As an example, the at least one channel outside COT(s) may be denoted as C₃, wherein C₃ ⊆C, i.e., C₃ is a subset of C. The UE may perform the following operations:
The UE may select a first channel (e.g., denoted as cⱼ) from C₃, and perform a Type-1 dynamic channel access procedure towards a PSFCH occasion on the channel cⱼ to determine availability of the channel cⱼ (e.g., whether the PSFCH occasion in the channel c₁ is available for PSFCH transmission).
For each channel cᵢ≠cⱼ, cᵢ ∈ C, the UE may perform a Type-2 dynamic channel access procedure on the channel cᵢ before a starting point of the PSFCH occasion on the channel cⱼ to determine availability of the channel cᵢ(i.e., whether the channel is available). For example, the UE may sense the channel cᵢ for at least a sensing interval T_{mc} (e.g., T_{mc}=25us) immediately before the starting point of the PSFCH occasion on the channel cⱼ, and determine that the channel cᵢ is available after sensing the channel cᵢ to be idle for at least the sensing interval T_{mc}.

In the case that all channels within the set of channels are within COT(s), the UE may perform a Type-2 dynamic channel access procedure on each channel within the set of channels independently to determine availability of each channel (e.g., whether a PSFCH occasion in each channel is available for PSFCH transmission).

Consequently, in step 304, the UE may determine availability of each channel within the set of channels. In other words, the UE may determine which channel(s) within the set of channels is(are) available. Then, in some embodiments, the UE may select all channels within the set of channels which are determined to be available in step 304 to perform PSFCH transmission(s).

In some embodiments, in the case that the UE cannot transmit PSFCH on all channels which are determined to be available (e.g., due to a power limitation), the UE may drop PSFCH transmission(s) according to priority(ies) of corresponding SL transmission(s). For example, the UE may drop PSFCH transmission(s) whose corresponding SL transmission(s) has(have) lower priority(ies).

According to some embodiments of the present disclosure, for a channel with SCS being 60 KHz, the UE may keep two symbols prior to an S-SSB occasion for performing a channel access procedure in the case that the S-SSB occasion is within a COT.

According to some embodiments of the present application, a BS (e.g., NE 102 as shown in FIG. 1) may transmit configuration information to one or more UEs (e.g., UE 104 as shown in FIG. 1). The configuration information may indicate at least one of:
a CAPC threshold for a UE to select channel(s) for perform S-SSB transmission (e.g., which is used in Embodiment 1-1); or
a COT duration threshold for a UE to determine whether to perform an SL transmission on a channel (e.g., which is used in Embodiment 2-2).

In an embodiment, the BS may transmit the configuration information to one or more UEs via at least one of: a MIB message, a SIB message, an RRC signaling, a MAC CE, or DCI.

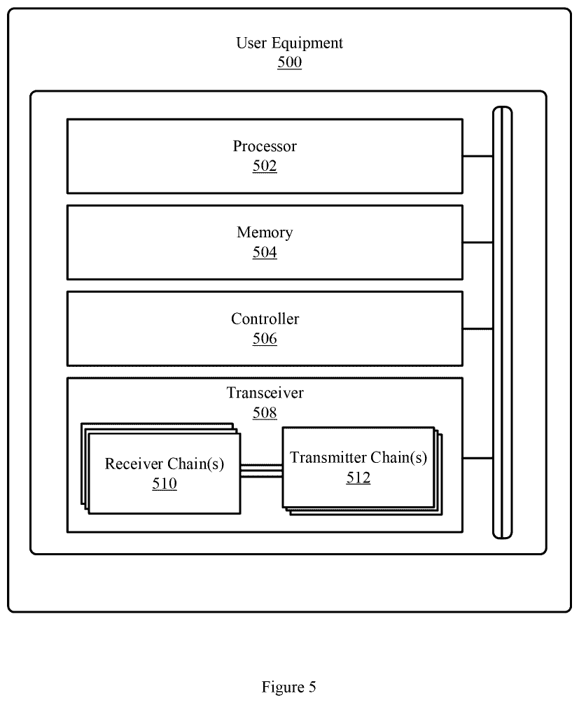

FIG. 5 illustrates an example of a UE 500 in accordance with aspects of the present disclosure. The UE 500 may include at least one processor 502 and at least one memory 504. Additionally, the UE 500 may also include one or more of at least one controller 506 or at least one transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to support a means for performing the operations of the methods described in the embodiments of the present disclosure. In an embodiment, the processor 502 may be configured to cause the UE 500 to: select a set of channels for a transmission over SL, wherein the transmission is one of: S-SSB transmission, SL transmission, or PSFCH transmission; and determine availability of each channel within the set of channels by performing a multiple channel access procedure of Type-independent or a multiple channel access procedure of Type-dependent on the set of channels for the transmission.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

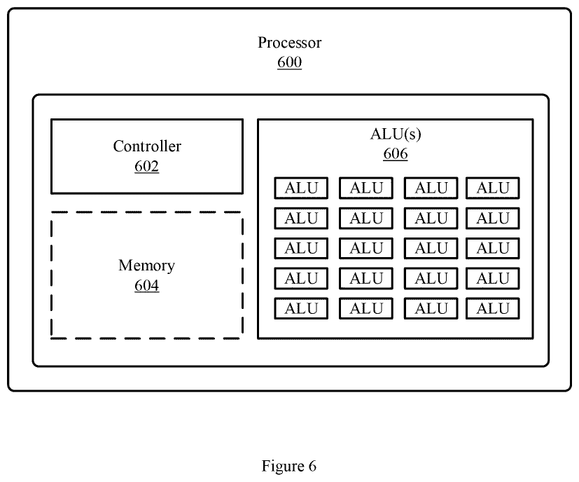

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, a layer 1 (L1), layer 2 (L2), or layer 3 (L3) cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs, and other functional units of the processor 600.

The memory 604 may include one or more caches (e.g., memory local to or included in the processor 600 or other memory, such RAM, ROM, DRAM, SDRAM, SRAM, MRAM, flash memory, etc.). In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support a means for performing the operations of the methods described in the embodiments of the present disclosure. In an embodiment, the controller 602 may cause the processor 600 to: select a set of channels for a transmission over SL, wherein the transmission is one of: S-SSB transmission, SL transmission, or PSFCH transmission; and determine availability of each channel within the set of channels by performing a multiple channel access procedure of Type-independent or a multiple channel access procedure of Type-dependent on the set of channels for the transmission.

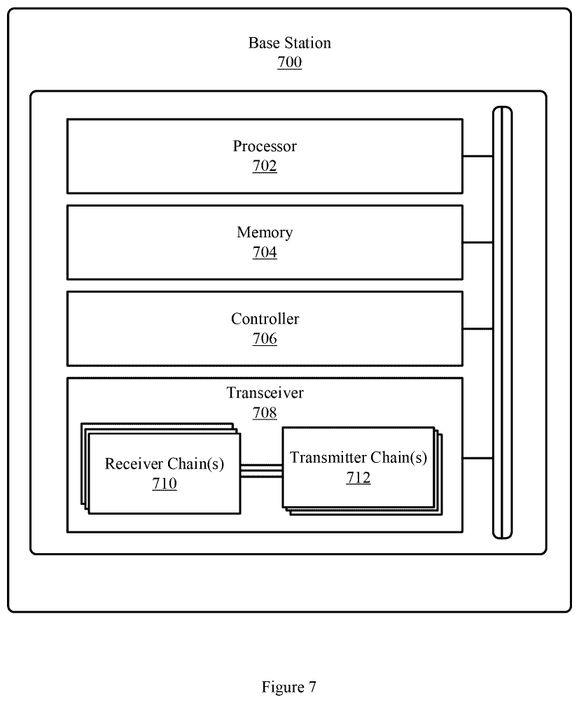

FIG. 7 illustrates an example of a BS 700 in accordance with aspects of the present disclosure. The BS 700 may include at least one processor 702 and at least one memory 704. Additionally, the BS 700 may also include one or more of at least one controller 706 or at least one transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the BS 700 to perform various functions of the present disclosure.

The memory 704 may include volatile or non-volatile memory. The memory 704 may store computer-readable, computer-executable code including instructions when executed by the processor 702 cause the BS 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the BS 700 to perform one or more of the functions described herein (e.g., executing, by the processor 702, instructions stored in the memory 704). For example, the processor 702 may support wireless communication at the BS 700 in accordance with examples as disclosed herein. The BS 700 may be configured to support a means for performing the operations of the methods described in the embodiments of the present disclosure. In an embodiment, the processor 702 may be configured to cause the BS 700 to: transmit, to a UE, configuration information for multiple channel access over SL, wherein the configuration information indicates: a CAPC threshold for the UE to select channel(s) for perform S-SSB transmission; or a COT duration threshold for the UE to determine whether to perform a sidelink transmission on a channel.

The controller 706 may manage input and output signals for the BS 700. The controller 706 may also manage peripherals not integrated into the BS 700. In some implementations, the controller 706 may utilize an operating system such as iOS®, ANDROID®, WINDOWS®, or other operating systems. In some implementations, the controller 706 may be implemented as part of the processor 702.

In some implementations, the BS 700 may include at least one transceiver 708. In some other implementations, the BS 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
select a set of channels for a transmission over sidelink (SL), wherein the transmission is one of: a sidelink synchronization signal block (S-SSB) transmission, an SL transmission, or a physical sidelink feedback channel (PSFCH) transmission; and
determine an availability of each channel within the set of channels by performing a multiple channel access procedure of Type-independent or a multiple channel access procedure of Type-dependent on the set of channels for the transmission.

2. The UE of claim 1, wherein performing the multiple channel access procedure of Type-independent includes:
Performing a channel access procedure on each channel within the set of channels independently; and
Determining a channel access type on each channel within the set of channels according to whether the channel is within a channel occupancy time (COT) or whether the channel is within a COT shared to the UE for performing the transmission.

3. The UE of claim 1, wherein in-performing the multiple channel access procedure of Type-dependent includes:
when at least one channel within the set of channels is outside one or more channel occupancy times (COTs), performing a Type-1 dynamic channel access procedure on a first channel within the at least one channel, and performing a Type-2 dynamic channel access procedure on each remaining channel within the set of channels other than the first channel.

4. The UE of claim 1, wherein, when the transmission is an S-SSB transmission, to select the set of channels, the at least one processor is configured to cause the UE to:
randomly select channels within a frequency range; or
prioritize selecting an anchor channel.

5. The UE of claim 4, wherein, to perform the multiple channel access procedure of Type-independent for the S-SSB transmission, the at least one processor is configured to cause the UE to:
individually determine a channel access type on each channel within the set of channels according to whether a target S-SSB occasion on the channel is within a channel occupancy time (COT); and
perform a channel access procedure on each channel within the set of channels based on the channel access type determined individually for each channel.

6. The UE of claim 1, wherein, when the transmission is an S-SSB transmission, the at least one processor is further configured to cause the UE to:
when an anchor channel within the set of channels is determined to be available, select the anchor channel to perform the S-SSB transmission; or
when no anchor channel is determined to be available:
randomly select a channel from all available channels within the set of channels to perform the S-SSB transmission;
randomly select a channel from at least one available channel within the set of channels and within one or more channel occupancy times (COTs) to perform the S-SSB transmission;
select all available channels within the set of channels to perform the S-SSB transmission;
select all available channels within the set of channels and within one or more COTs to perform the S-SSB transmission; or
select a channel from at least one channel within the set of channels and within the one or more COTs to perform the S-SSB transmission based on channel access priority class(es) (CAPC(s)) corresponding to the one or more COTs.

7. The UE of claim 1, wherein, when performing the multiple channel access procedure of Type-independent for SL transmission, to select the set of channels, the at least one processor is configured to cause the UE to:
prioritize selecting a channel within a channel occupancy time (COT) shared to the UE when the SL transmission is intended for a UE initiating the COT.

8. The UE of claim 1, wherein, to perform the multiple channel access procedure of Type-independent for SL transmission, the at least one processor is configured to cause the UE to:
individually determine a channel access type on each channel within the set of channels according to whether the channel is within a channel occupancy time (COT) shared to the UE for performing at least one SL transmission and whether the SL transmission is at least intended for a UE initiating the COT; and
perform a channel access procedure on each channel within the set of channels based on the channel access type determined individually for each channel.

9. The UE of claim 1, wherein, when the transmission is SL transmission, the at least one processor is further configured to cause the UE to:
select all channels determined to be available to perform the SL transmission.

10. The UE of claim 1, wherein, when the transmission is the PSFCH transmission, to select the set of channels, the at least one processor is configured to cause the UE to:
select one or more channels having PSFCH resources that correspond to one or more SL transmissions to which the UE transmits hybrid automatic repeat request (HARQ) feedback.

11. The UE of claim 1, wherein, to perform the multiple channel access procedure of Type-independent for PSFCH transmission, the at least one processor is configured to cause the UE to:
individually determine a channel access type on each channel within the set of channels according to whether the channel is within a channel occupancy time (COT) shared to the UE for performing PSFCH transmissions and whether at least one of the PSFCH transmissions is intended for a UE initiating the COT; and
perform a channel access procedure on each channel within the set of channels based on the channel access type determined individually for each channel.

12. The UE of claim 1, wherein, when the transmission is the PSFCH transmission, the at least one processor is further configured to cause the UE to:
select all channels determined to be available to perform PSFCH transmission; or
drop PSFCH transmissions according to priorities of corresponding SL transmissions when the UE cannot transmit PSFCH on all channels determined to be available.

13. The UE of claim 1, wherein, to perform the multiple channel access procedure of Type-dependent for S-SSB transmission, the at least one processor is configured to cause the UE to:
when at least one channel within the set of channels is outside one or more channel occupancy times (COTs):
select a first channel within the at least one channel;
perform a Type-1 dynamic channel access procedure on the first channel to determine whether an S-SSB occasion in the first channel is available for S-SSB transmission; and
perform a Type-2 dynamic channel access procedure on each remaining channel within the set of channels other than the first channel before a starting point of the S-SSB occasion in the first channel; or
when all channels within the set of channels are within the one or more COTs, perform a Type-2 dynamic channel access procedure on each channel within the set of channels independently.

14. The UE of claim 1, wherein, when performing the multiple channel access procedure of Type-dependent for SL transmission, to select the set of channels, the at least one processor is configured to cause the UE to:
prioritize selecting at least one channel outside one or more channel occupancy times (COTs).

15. The UE of claim 1, wherein, to perform the multiple channel access procedure of Type-dependent for SL transmission, the at least one processor is configured to cause the UE to:
when at least one channel within the set of channels is outside one or more channel occupancy times (COTs):
select a first channel within the at least one channel;
perform a Type-1 dynamic channel access procedure on the first channel; and
perform a Type-2 dynamic channel access procedure on each remaining channel within the set of channels other than the first channel before the SL transmission on the first channel; or
when all channels within the set of channels are within the one or more channel occupancy times (COTs), perform a Type-2 dynamic channel access procedure on each channel within the set of channels independently.

16. The UE of claim 1, wherein, when performing the multiple channel access procedure of Type-dependent for SL transmission, the at least one processor is further configured to cause the UE to:
when a channel determined to be available is within a channel occupancy time (COT), determine whether to perform the SL transmission on the channel based on a remaining COT duration of the COT.

17. The UE of claim 1, wherein, to perform the multiple channel access procedure of Type-dependent for PSFCH transmission, the at least one processor is configured to cause the UE to:
when at least one channel within the set of channels is outside one or more channel occupancy times (COTs):
select a first channel within the at least one channel;
perform a Type-1 dynamic channel access procedure on the first channel to determine whether a PSFCH occasion in the first channel is available for PSFCH transmission; and
perform a Type-2 dynamic channel access procedure on each remaining channel within the set of channels other than the first channel before a starting point of the PSFCH occasion in the first channel; or
when all channels within the set of channels are within the one or more COTs, perform a Type-2 dynamic channel access procedure on each channel within the set of channels independently.

18. A processor for wireless communication, comprising:
at least one controller coupled with at least one memory and configured to cause the processor to:
select a set of channels for a transmission over a sidelink (SL), wherein the transmission is one of: a sidelink synchronization signal block (S-SSB) transmission, an SL transmission, or a physical sidelink feedback channel (PSFCH) transmission; and
determine an availability of each channel within the set of channels by performing a multiple channel access procedure of Type-independent or a multiple channel access procedure of Type-dependent on the set of channels for the transmission.

19. A base station (BS) for wireless communication, comprising:
at least one memory; and
at least one processor coupled with the at least one memory and configured to cause the BS to:
transmit, to a user equipment (UE), configuration information for multiple channel access over sidelink (SL), wherein the configuration information indicates:
a channel access priority class (CAPC) threshold for the UE to select one or more channels for perform sidelink synchronization signal block (S-SSB) transmission; or
a channel occupancy time (COT) duration threshold for the UE to determine whether to perform a sidelink transmission on a channel.

20. A method performed by a user equipment (UE), the method comprising:
selecting a set of channels for a transmission over a sidelink (SL), wherein the transmission is one of: a sidelink synchronization signal block (S-SSB) transmission, an SL transmission, or a physical sidelink feedback channel (PSFCH) transmission; and
determining an availability of each channel within the set of channels by performing a multiple channel access procedure of Type-independent or a multiple channel access procedure of Type-dependent on the set of channels for the transmission.
